(19) United States
(12) Patent Application Publication
(10) Pub. No.: US 2014/0141819 A1
(43) Pub. Date: May 22, 2014

(54) MOBILE PHONE WITH INBUILT PROTECTION FOR USER INFORMATION AND METHOD THEREOF

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventors: JING-TING WANG, Shenzhen (CN); XIAN QIAN, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 13/707,972

(22) Filed: Dec. 7, 2012

(30) Foreign Application Priority Data
Nov. 20, 2012 (CN) 2012104718939

(51) Int. Cl. H04W 4/14

(52) U.S. Cl. CPC H04W 4/14
USPC 455/466

(57) ABSTRACT

The disclosure provides a mobile phone with protection for user information and a user information protection method adapted for the mobile phone. When the mobile phone is lost or stolen, the mobile phone user can send a short message to the mobile phone, using another mobile phone, the original mobile phone recognizes the contents of the short message and will determine that the short message is a command for deleting the user information if a validation code is included in the short message, and accordingly deletes the user information in a SIM card and also stored in the mobile phone.

### BACKGROUND

1. Technical Field

The disclosure relates to mobile phones and, more particularly, to a mobile phone with protection for user information and a user information protection method adapted for the mobile phone.

2. Description of Related Art

Small mobile phones are easily lost or stolen. User information stored in the mobile phone belonging to the owner of the mobile phone may be illegally accessed after the loss or theft, which may result in loss or privacy intrusion for the owner.

Therefore, what is needed is a mobile phone for protecting user information to overcome the described shortcoming.

### BRIEF DESCRIPTION OF THE DRAWINGS

FIG. 1 is a block diagram of a mobile phone with protection for user information in accordance with an exemplary embodiment.

FIG. 2 is a block diagram of a user information protecting system of the mobile phone of FIG. 1.

FIG. 3 is a flowchart of a method for protecting user information adapted for the mobile phone of FIG. 1.

### DETAILED DESCRIPTION

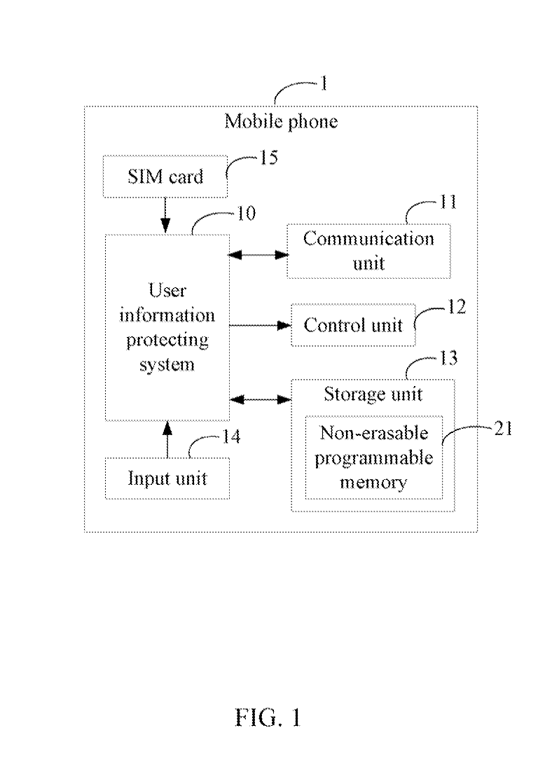

FIG. 1 is a block diagram of a mobile phone capable of protecting user information in accordance with an exemplary embodiment. The mobile phone 1 with protection for user information includes a user information protecting system 10, a communication unit 11, a control unit 12, a storage unit 13, and an input unit 14. When a Subscriber Identification Module (SIM) card 15 is located in the mobile phone 1, the mobile phone 1 may communicate with other mobile phones 1 in the normal manner via the communication unit 11. The input unit 14 generates signals in response to user inputs. The storage unit 13 includes a non-erasable programmable memory 21 and an erasable programmable memory (not shown). The non-erasable programmable memory 21 stores non-erasable information, such as an International Mobile Equipment Identity (IMEI) number of the mobile phone 1. The erasable programmable memory stores erasable information, such as a predefined ringtone for incoming calls.

When the mobile phone 1 is restored to factory settings or the system of the mobile phone is updated, the information of the erasable programmable memory will be deleted or reset in accordance with factory settings, whereas the information of the non-erasable programmable memory 21 cannot be deleted and is permanently stored in the mobile phone 1. The control unit 12 runs the user information protecting system 10 and performs each function of each module of the user information protecting system 10.

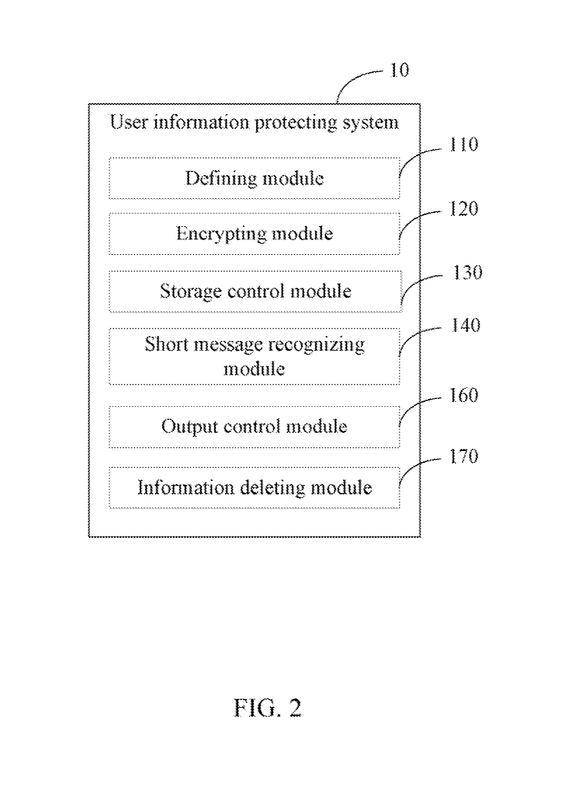

As shown in FIG. 2, the user information protecting system 10 further includes a defining module 110, an encrypting module 120, a storage control module 130, a short message recognizing module 140, an output control module 160, and an information deleting module 170.

The defining module 110 controls a display unit (not shown) to display a user interface and defines at least one validation code in the user interface, in response to user inputs through the input unit 14, wherein the at least one validation code activates the deletion of user information in the SIM card 15 and stored in the mobile phone 1. Each of the at least one validation code is composed of one or more digits, or letters, or words, or other characters. Both the mobile phone 1 and the SIM card 15 store the user information, for example, the user information in both locations may include test messages (short messages) in the inbox and sent messages in the outbox, recent calls, images & videos, and list of contacts.

For example, the defining module 110 defines a first validation code “SCDXX123456” for deleting short messages and a second validation code “SCTXL123456” for deleting list of contacts. In another embodiment, the defining module 110 only defines a single validation code “SCGRXX123456” for deleting all user information in the SIM card 15 and the mobile phone 1. An operation of defining the at least one validation code from the defining module 110 can be preset by the user when the user starts to use the mobile phone 1 the first time, or any time in the course of using the mobile phone 1.

The encrypting module 120 encrypts the user interface after at least one validation code has been defined in the defining module 110 through the user interface. For example, the encrypting module 120 can set a password for the appearance of the user interface, that is, if a user enters the right password for the user interface, the user can look at, change, or delete contents (i.e., the at least one validation code) of the defining module 110 through the user interface. The storage control module 130 stores the at least one validation code defined in the defining module 110 in the non-erasable programmable memory 21.

When the mobile phone user or owner has need (when the mobile phone 1 is lost or stolen), the user can use another mobile phone to send a short message to the mobile phone 1, the communication unit 11 receives the short message, and the short message recognizing module 140 is able to compare the short message with the at least one validation code in the non-erasable programmable memory 21, to determine whether the validation code included in the short message matches the at least one validation code in the non-erasable programmable memory 21. When the short message recognizing module 140 determines that there is a match, the short message is taken as the activation or trigger to delete the user information, and the information deleting module 170 deletes the user information in the SIM card 15 and in the mobile phone 1 and the output control module 160 does not display any short message. When the short message recognizing module 140 determines that the short message does not include the at least one validation code in the non-erasable programmable memory 21, the output control module 160 does display the short message.

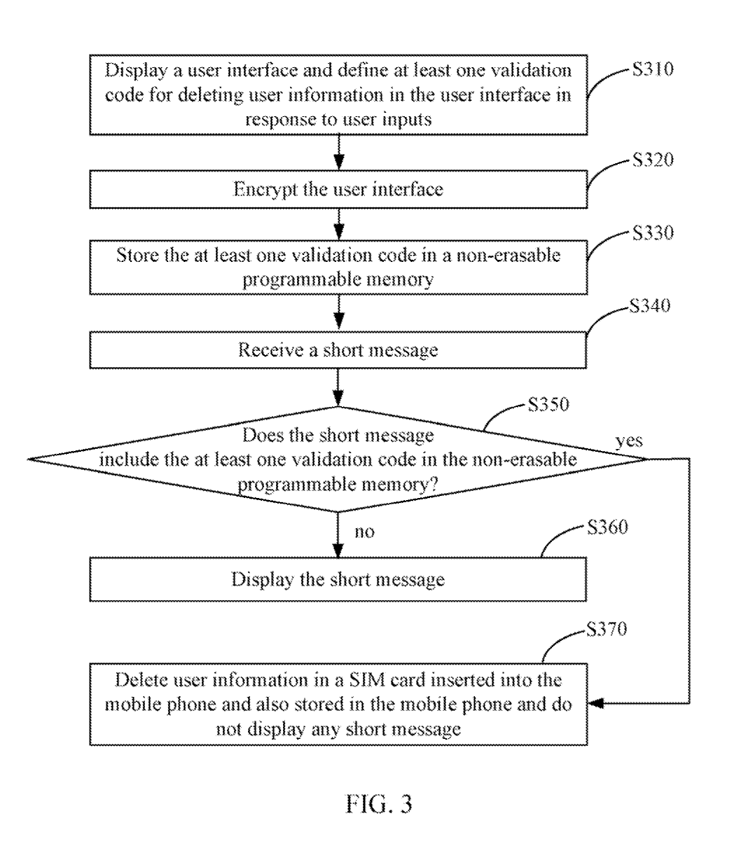

FIG. 3 shows a flowchart of an embodiment of a method for protecting user information adapted for the mobile phone of FIG. 1. In step S310, the defining module 110 controls the display unit to display the user interface and accepts a definition of the at least one validation code through the user interface of the input unit 14. In step S320, the encrypting module 120 encrypts the user interface after the defining operation of the defining module 110. In step S330, the storage control module 130 stores the at least one validation code from the defining module 110 in the non-erasable programmable memory 21. In step S340, the communication unit 11 receives a short message. In step S350, the short message recognizing module 140 analyzes the short message for the presence of any validation code and determines whether any validation code in the short message matches or includes the at least one validation code in the non-erasable programmable memory 21.

In step S370, when the short message recognizing module 140 determines that the short message does include the at least one validation code in the non-erasable programmable memory 21, the information deleting module 170 deletes the user information in the SIM card 15 and in the mobile phone 1 and the output control module 160 does not display any short message. In step S360, when the short message recognizing module 140 determines that the short message does not include or match the at least one validation code in the non-erasable programmable memory 21, the output control module 160 does display the short message.

If and when the mobile phone 1 is lost or stolen, the mobile phone user simply uses another mobile phone, or any other means, to send a short message to the mobile phone 1, the mobile phone 1 recognizes the short message and determines that the short message is a command for deleting the user information, and the user information in the SIM card 15 and in the mobile phone 1 is accordingly deleted. Therefore, the mobile phone 1 protects owner and user information contained in it.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. A mobile phone comprising:
a storage unit for storing at least one validation code;
a communication unit for receiving and sending a wireless signal; and
a control unit;
one or more programs stored in the storage unit, executable by the control unit, the one or more programs comprising:
a short message recognizing module operable to determine whether a short message comprises the at least one validation code when the communication unit receives the short message; and
an information deleting module operable to delete user information in a SIM card located in the mobile phone and stored in the mobile phone, when the short message comprises the at least one validation code.

2. The mobile phone as recited in claim 1, wherein the storage unit comprises a non-erasable programmable memory and the one or more programs further comprise a storage control module operable to store the at least one validation code in the non-erasable programmable memory.

3. The mobile phone as recited in claim 1, wherein the one or more programs further comprise an output control module operable not to display any short message when the short message comprises the at least one validation code.

4. The mobile phone as recited in claim 3, wherein the output control module is further operable to display the short message when the short message does not comprise the at least one validation code.

5. The mobile phone as recited in claim 1, wherein the one or more programs further comprise a defining module operable to control to display a user interface and define the at least one validation code in the user interface in response to user inputs.

6. The mobile phone as recited in claim 5, wherein an operation of defining the at least one validation code from the defining module can be performed when the user starts to use the mobile phone the first time or in the course of using the mobile phone.

7. The mobile phone as recited in claim 5, wherein the one or more programs further comprise an encrypting module operable to encrypt the user interface after the defining module defines the at least one validation code.

8. The mobile phone as recited in claim 7, wherein the encrypting module sets a password for the user interface in response to an user input, when a user enters the right password for the user interface, the user can look at, change, or delete the at least one validation code of the user interface.

9. The mobile phone as recited in claim 1, wherein the at least one validation code is defined to delete the user information in the SIM card and stored in the mobile phone and the at least one validation code is composed of one or more digits, letters, words, or other characters.

10. The mobile phone as recited in claim 1, wherein the user information comprises short messages in inbox and outbox, recent calls, images & videos, and list of contacts.

11. A user information protection method adapted for a mobile phone, wherein the mobile phone stores at least one validation code, the method comprising:
when receiving a short message, determining whether the short message comprises the at least one validation code; and
when the short message comprises the at least one validation code, deleting user information in a SIM card located in the mobile phone and stored in the mobile phone.

12. The user information protection method as recited in claim 11, wherein the mobile phone comprises a non-erasable programmable memory and the at least one validation code is stored in the non-erasable programmable memory.

13. The user information protection method as recited in claim 11, further comprising:
when the short message comprises the at least one validation code, not displaying any short message.

14. The user information protection method as recited in claim 11, further comprising:
when the short message does not comprise the at least one validation code, displaying the short message.

15. The user information protection method as recited in claim 11, further comprising:
displaying a user interface and defining the at least one validation code in the user interface in response to user inputs.

16. The user information protection method as recited in claim 15, wherein the defining operation can be performed when a user starts to use the mobile phone the first time or in the course of using the mobile phone.

17. The user information protection method as recited in claim 11, wherein the at least one validation code is defined to delete the user information in the SIM card and stored in the mobile phone and each of the at least one validation code is composed of one or more digits, letters, words, or other characters.

18. The user information protection method as recited in claim 11, wherein the user information comprises short messages in inbox and outbox, recent calls, images & videos, and list of contacts in the mobile phone.
